(19) United States
(12) Patent Application Publication
(10) Pub. No.: US 2003/0169183 A1
(43) Pub. Date: Sep. 11, 2003

(54) Parking meter reset device

(76) Inventors: Valery Y. Korepanov, Lviv (UA); Rikhard Y. Berkman, Lviv (UA); George MacKay, Nova Scotia (CA); Bohdan O. Oliyarnyk, Lviv (UA); Andriy V. Hrabchak, Lviv (UA); Serhiy P. Smokov, Lviv (UA)

Correspondence Address: HAYES SOLOWAY PC, 130 W. Cushing Street, Tucson, AZ, 85701, US

(21) Appl. No.: 10/304,193

(22) Filed: Nov. 26, 2002

(30) Foreign Application Priority Data
Nov. 27, 2001 (CA) 2,363,915

(51) Int. Cl. G08G 1/14

(52) U.S. Cl. 340/932.2; 340/933; 194/900

(57) ABSTRACT

The invention is directed to a method and device for resetting a parking meter associated with a parking space. The reset device comprises a magnetic vehicle movement detector, a radiated beam vehicle detector and a controller. The controller receives a wake-up signal from the parking meter and activates the magnetic vehicle movement detector for detecting vehicle movement. After vehicle movement has been detected, the controller activates the radiated beam vehicle detector to determine the presence/absence of a vehicle in the parking space providing a presence/absence signal such that the absence signal can be used to reset the parking meter. The radiated beam vehicle detector may also verify whether the beam propagation path between the parking meter and a parked car is intentionally blocked. The vehicle detectors may also be tested when a car is first parked to verify their operation. The magnetic vehicle movement detector is preferably a search-coil magnetometer for detecting changes in adjacent magnetic fields and the radiated beam detector may include an infrared detector or an ultrasonic detector, or both made to operate sequentially or simultaneously.

### FIELD OF THE INVENTION

The invention relates generally to parking meters, and more particularly to a reset device for electronic parking meters.

### BACKGROUND OF THE INVENTION

The payment for parking spaces, particularly at the level of street parking, is generally enforced through the use of parking meters, a parking meter being associated with each parking space. To purchase parking, a driver may insert coins, a debit card or a credit card into the parking meter and select the parking time desired. The parking meter then times a preset period of time which is visible on the face of the meter. After the time is expired, the meter shows a violation indication. If a vehicle is present in the parking space with the violation indication showing, a parking enforcement officer can issue a citation for the parking violation. Parking meters used in this manner encourage drivers to use spaces only for the time that they require within the confines of the parking limit for each particular space. In addition to generating revenue for the city, such a system provides for the greater availability and use of parking spaces.

Since drivers are required to pay for parking in advance at these meters, they will often overestimate their parking needs in order to avoid the possibility of getting a citation. Thus, a driver may pay for the maximum time, such as 1 or 2 hours, permitted at a particular meter. It therefore frequently occurs that a driver will leave a meter with time still remaining on the meter. This permits another motorist to park either without paying anything by using some or all of the balance of the time remaining on the meter or with paying only a small amount to top up the time remaining to the maximum needed. This deprives the city of revenue by permitting motorists to park without paying the full amount of their use of the parking spaces.

To overcome this drawback, a number of systems have been developed whereby the time remaining on parking meters is reset back to zero when a vehicle leaves the parking space by detecting the absence of a vehicle. For example, U.S. Pat. No. 3,324,647 which issued on Jun. 13, 1967 to Jedynak detects a decrease in capacitance when a vehicle leaves a parking space and then resets the meter. U.S. Pat. No. 3,018,615 which issued on Jun. 30, 1962; U.S. Pat. No. 3,194,005 which issued on Jul. 13, 1965 to Schalow and U.S. Pat. No. 3,930,363 which issued on Jan. 6, 1976 to Rubenstein describe parking devices which magnetically detect the presence and absence of a vehicle in a parking space and reset the parking meter in the absence of a vehicle. Similarly, U.S. Pat. No. 4,043,117 which issued on Aug. 23, 1977 to Maresca et al and U.S. Pat. No. 4,825,425 which issued on Apr. 25, 1989 to Turner use infrared light to detect the absence of a vehicle for resetting the meter. Turner discloses a reset device with an infrared radiation and receiving device, having minimum power requirements, for erasing any parking time remaining on a parking meter and resetting the parking meter when a vehicle parked in the space controlled by the parking meter has left, leaving the space empty. The parking meter reset device is provided with a housing minimising detection of stray radiation, such as from ambient sunlight, which could interfere with proper operation of the device. The housing is constructed to assure that should someone attempt to thwart operation of the parking meter by blocking the transmission or reception of the radiation, only the reset device would be disabled, and the parking meter itself would continue to operate, functioning as a non-resettable parking meter.

U.S. Pat. No. 3,535,870 which issued on Oct. 27, 1970 to Mitchell describes a parking meter transmitter that transmits periodic bursts of ultrasonic energy and a receiver for receiving such energy after reflection from a vehicle in the parking space. On the departure of the vehicle, the absence of a reflection causes the parking meter to reset and to deactivate the controller until the operator of the next parked vehicle reactivates the parking meter. U.S. Pat. No. 3,999,372 which issued on Dec. 28, 1976 discloses a parking meter with a sonic pulse transmitter and receiver for resetting the meter when the parked car is removed. The transmitter is shut off for a brief period following each pulse to enable reception of the reflected sonic pulse without confusion with the transmitted pulse. Other patent references that include ultrasonic detection for resetting parking meters include U.S. Pat. No. 5,442,348 which issued on Aug. 15, 1995 to Mushell; U.S. Pat. No. 6,195,015 which issued on Feb. 27, 2001 to Jacobs et al and the PCT Application filed on Mar. 8, 2000 by Saar et al and published under the International Publication No. WO 00/55821 on Sep. 21, 2000.

A further resetting device according to Japanese Patent No. JP53120599 A2, which was published on Oct. 21, 1978, includes two parallel channels of ultrasonic waves and light radiation in the direction of the parking space and detection of the reflected signals from the vehicle. The reflected signals are then transformed into electric signals and processed in order to produce the corresponding control signal and to reset the parking meter if the vehicle left the parking place.

A problem experienced by prior art parking meter reset devices, whether they detect sonic or light reflected radiation, is the detection of erroneous radiation which prevents the device from resetting properly. Additionally, the parking meter may fail to operate properly when the radiation path is blocked between the device and the parking space.

Another disadvantage of known reset devices is the excessive use of power increasing maintenance costs by the necessity to change the batteries frequently.

Therefore, there is a need for a parking meter reset device which will operate reliably while conserving power.

### SUMMARY OF THE INVENTION

The invention is directed to a vehicle monitoring device for a parking meter associated with a parking space. The vehicle monitoring device comprises a magnetic vehicle movement detector, a radiated beam vehicle detector and a controller. The controller receives a wake-up signal from the parking meter and activates the magnetic vehicle movement detector for detecting vehicle movement. The controller then activates the radiated beam vehicle detector to determine the presence/absence of a vehicle in the parking space after vehicle movement has been detected and indicates the presence/absence of a vehicle in the parking space.

In accordance with further aspect of the invention, the controller may further control the parking meter to reset the parking meter in the absence of a vehicle in the parking space.

In accordance with another aspect of this invention, the magnetic vehicle movement detector is a magnetometer for detecting changes in adjacent magnetic fields, and is preferably a search-coil magnetometer.

In accordance with another aspect of this invention, the radiated beam detector may include an infrared detector, an ultrasonic detector or both operating sequentially or simultaneously. Each detector includes a transmitter unit for radiating a beam towards the parking space and a receiver unit for detecting the beam reflected from a vehicle in the parking space.

In accordance with a specific aspect of this invention, the infrared detector transmitter unit comprises a transmitter amplifier for amplifying a coded pulse sequence received from the controller and a transmitter for transmitting the coded pulse sequence as an infrared beam, the transmitter amplifier being a variable gain power amplifier controlled by the controller. The receiver unit comprises a receiver for detecting the reflected infrared beam, a receiver amplifier for amplifying the received signal, a pulse generator for converting the amplified signal to a pulse, a delay cell for receiving a signal from the controller when the code pulse sequence is generated and a shift register for receiving the outputs of the pulse generator and the delay cell to provide an output to the controller as an indication of the presence of a vehicle.

In accordance with a further specific aspect of this invention, the ultrasonic detector unit comprises a transmitter amplifier for amplifying a coded pulse sequence received from the controller and a transmitter for transmitting the coded pulse sequence as an ultrasonic beam, the transmitter amplifier being a variable gain power amplifier controlled by the controller. The ultrasonic receiver unit comprises a receiver for detecting the reflected ultrasonic beam, a receiver amplifier for amplifying the received signal, a passband filter for filtering the amplified signal and a pulse generator for converting the filtered signal to a pulse to provide an output to the controller as an indication of the presence of a vehicle.

In accordance with another aspect, the present invention is directed to a method of resetting a parking meter associated with a parking space for a vehicle, which comprises the steps of magnetically sensing movement of a vehicle within the parking space, subsequently detecting the absence of the vehicle within the parking space and cancelling any paid time on the meter. The first step may include sensing a payment for parking time on the meter prior to sensing the movement of a vehicle. The second step may include activating a radiated beam vehicle detector in response to a sensed vehicle movement, transmitting a beam towards the parking space and detecting the absence of a reflected beam as an indication of the absence of a vehicle in the parking space. Preferably the radiated beam is a coded infrared beam, a coded ultrasonic beam or both.

In accordance with a further aspect of this invention, the infrared beam may be the first to be transmitted followed by the ultrasonic beam, or vice-versa, to determine and confirm the absence of a vehicle.

In accordance with another aspect of this invention, both ultrasonic and infrared detectors may be calibrated by transmitting both ultrasonic and infrared towards a parked vehicle for which payment has been made, verifying the detectors' ability to detect a vehicle. Further by transmitting a radiated beam towards the parking space at different amplification levels, the repeated detection of a reflected beam is an indication of a blocked beam propagation path.

Other aspects and advantages of the invention, as well as the structure and operation of various embodiments of the invention, will become apparent to those ordinarily skilled in the art upon review of the following description of the invention in conjunction with the accompanying drawings.

### BRIEF DESCRIPTION OF THE DRAWINGS

The invention will be described with reference to the accompanying drawings, wherein:

FIG. 1 is a plan view illustrating a group of parking spaces provided with parking meters having reset devices therein in accordance with the present invention;

FIG. 2 illustrates a parking meter mounted on a pole incorporating a reset device in accordance with the present invention;

FIG. 3 is a block diagram of the reset device; and

FIG. 4 is a schematic diagram of circuitry for the parking meter reset device in accordance with a preferred embodiment of the present invention.

### DETAILED DESCRIPTION OF THE INVENTION

Parking meters generally have a violation indicator or some other unpaid time indicator, a timer for timing a preselected period of time for a vehicle to remain parked in the parking space to which the parking meter is associated, and a coin or card responsive actuator for deactivating the violation indicator and actuating the timer for a period of time selected in accordance with the payment utilised to initiate operation of the actuator, following which the violation indicator is actuated.

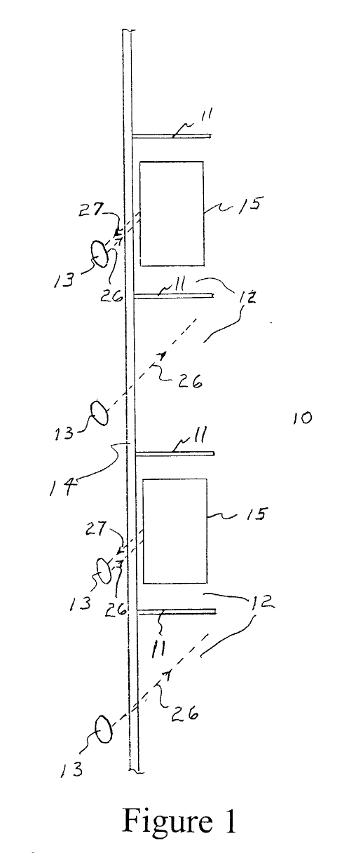

FIG. 1 illustrates a typical parking space arrangement along one side of a street 10. Lines 11 demark the parking spaces 12 along the curb 14 of the street 10 in which cars 15 may be parked. These lines 11, by way of example, might be painted on the pavement of street 10. A parking meter 13 is associated with each parking space 12 and is positioned at the curb 14. The meter 13 may be positioned near the front or the back of each space 12.

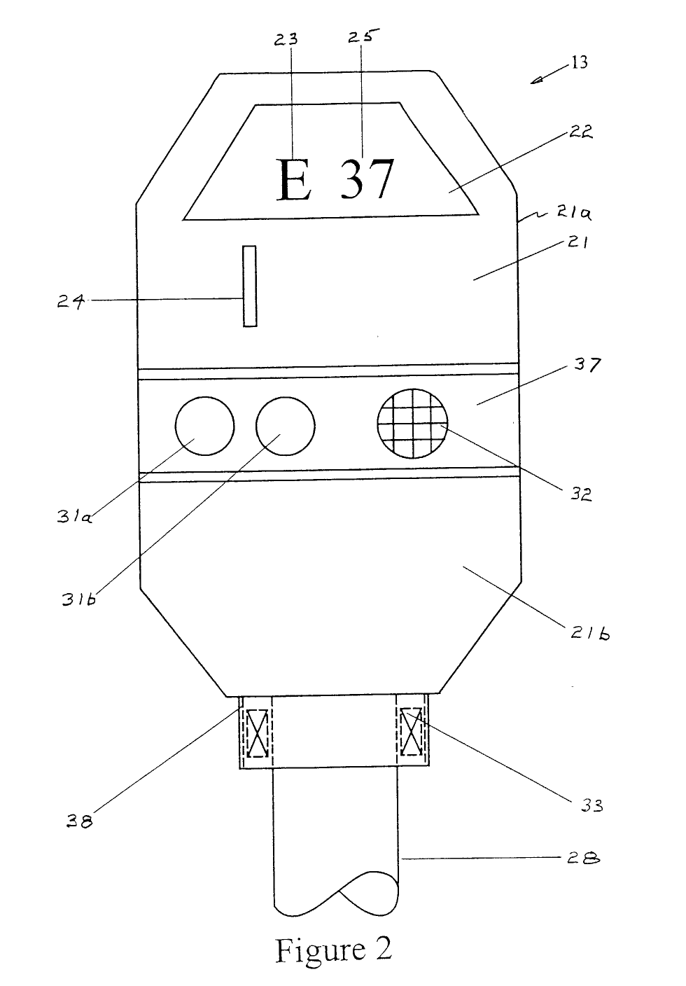

FIG. 2 illustrates the implementation of the present invention in an electronic parking meter 13 mounted on a pole 28. A conventional parking meter 13 has the housing 21 made up of an upper 21a and a lower section 21b with a window 22 in the upper section 21b. Within the window 22 a violation indicator 23 is visible when the parking meter 13 is not timing a parking interval for which payment has been made. A card/coin receiving slot 24 is provided in housing 21a. When a driver wishes to make payment for parking time, a card or coins are inserted into the slot 24. This action causes the parking meter controller to wake-up, disengage the violation indicator 23 and indicate the paid parking time 25. Though coins or cards have been suggested as a method of payment, meters with any other methods of payment may be used with the present invention.

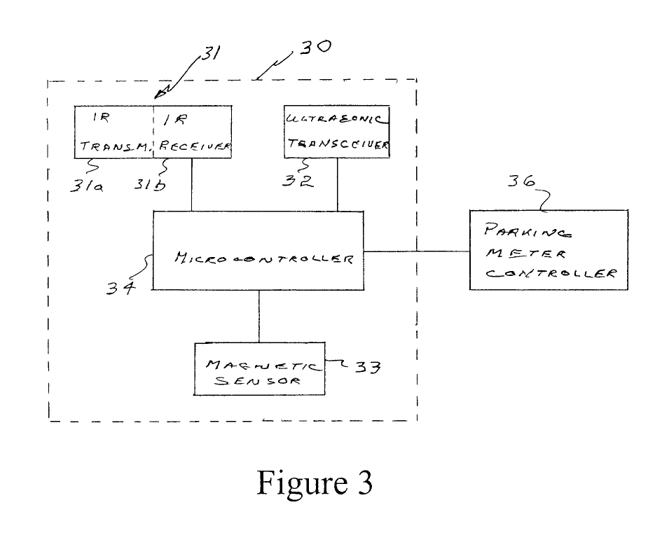

In accordance with the present invention, as further illustrated in FIGS. 1 to 3, the parking meter 13 is provided with a reset device 30 for detecting the presence/absence of a vehicle 15 in a parking space 12 controlled by the parking meter 13. The reset device 30 includes an infrared device 31 having an infrared transmitter element 31a and receiver element 31b, an ultrasonic transceiver element 32 and a magnetic sensor 33. These are all controlled by a reset device 30 microcontroller 34 which is connected to the parking meter controller 36.

For convenience and versatility, the reset device 30 including the sensor elements 31, 32 and 33 and the controller 34 can be mounted within a separate housing section 37 that is sandwiched between the upper 21a and lower 21b sections of the parking meter 13 housing 21. Such an arrangement permits the delivery of parking meters to a client with or without the reset device 30. To protect the sensors elements 31, 32 and 33 against vandalism, the infrared transmitter 31a and receiver 31b openings in housing section 37 may be protected by a transparent material such as plexiglass; the ultrasonic sensor element 32 opening may be protected by a grid; and the search-coil sensor winding 33 may be protected by a metallic skirt 38 in the lower housing section 21b.

Generally, the reset device 30 would operate in the following manner in conjunction with the parking meter 13. After a payment is made, the parking meter 13 controller 36 wakes-up the reset device 30 controller 34. The controller 34 switches on the magnetic sensor 33 and waits for an interruption signal from it. The magnetic sensor 33 senses any movement of magnetic masses such as a vehicle body. If a parked vehicle 15, as seen on FIG. 1, is not moving, magnetic sensor 33 does not provide an output signal signifying movement. The infrared element 31 and ultrasonic element 32 remain switched off during this time.

As soon as any movement of a magnetic mass occurs within the sensitivity zone of the magnetic sensor 33, the reset device 30 controller 34 turns the infrared element 31 on. As illustrated in FIG. 1, a beam of radiated energy from infrared transmitter 31a is transmitted generally along a path 26 toward the parking space 12 associated with the respective parking meter 13. If a magnetic sensor 23 output signal has been triggered by some interference action such as the movement of a magnetic mass other than the vehicle 15 leaving the parking space 12 or some other form of electro-magnetic interference, and the vehicle 15 is still in its parking space 12, then a portion of the radiated infrared energy is reflecting back to parking meter 13 generally along a reflection path 27. This energy is detected by the infrared receiver 31b and a parking confirmation signal is sent to the parking meter 13 controller 36 by the reset device 30 controller 34.

If the infrared receiver 31b does not receive a reflected infrared signal, then the reset device 30 controller 34 switches on the ultrasonic element 32 which transmits an ultrasonic pulse beam towards the parking space 12 and receives a reflected signal if a vehicle 15 is present. If the magnetic sensor 33 produces a “movement” output signal and the infrared element 31 and ultrasonic element 32 do not receive reflected signals, the reset device 30 controller 34 generates a reset signal and sends it to the parking meter 13 controller 36. The reset signal causes the controller 36 to reset the remaining paid time indicator 25 showing in the window 22 to zero and to activate the violation indicator 23.

In the above embodiment the reset device 30 has been described as having a controller 34 separate from the parking meter 13 controller 36, however this need not be case in order to implement the present invention. In a fully integrated parking meter system, the functions performed by the controller 34 may be implemented in the controller 36. In addition, the transmitted infrared and ultrasonic beams need not be particularly focussed.

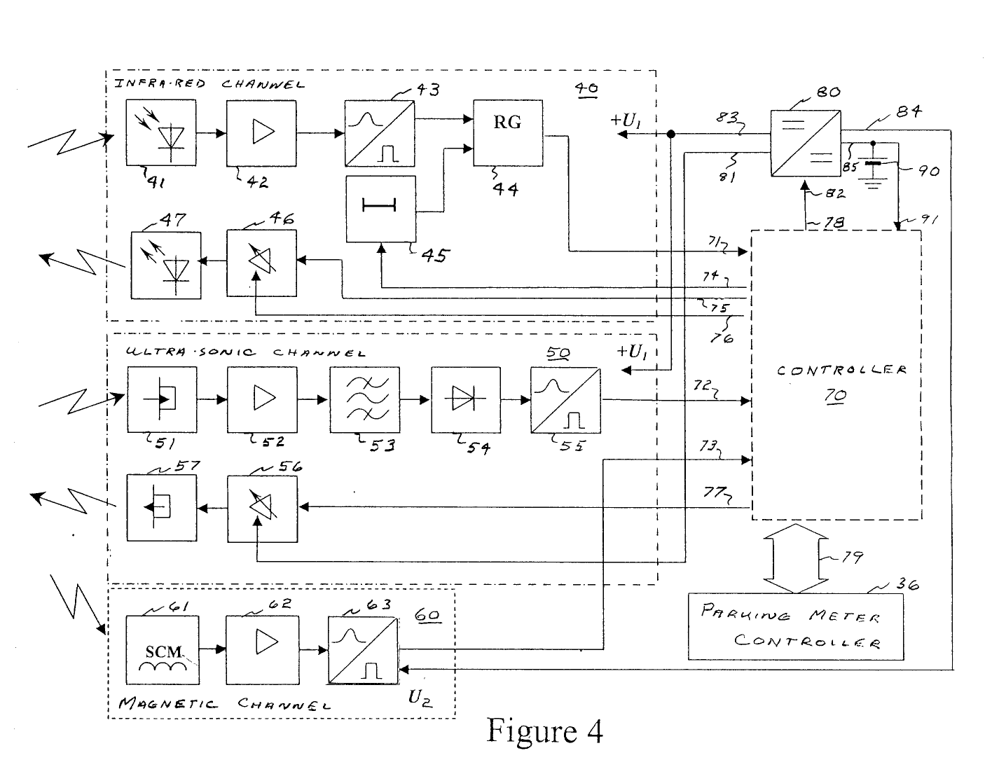

FIG. 4 illustrates one embodiment of circuitry which can be used to implement the reset device 30 in accordance with the present invention. The main components of the device include an infrared channel 40, an ultrasonic channel 50, a magnetometer channel 60, a reset device microcontroller 70, a programmable power supply 80 and a battery 90.

The infrared channel comprises an infrared receiver 41, an amplifier 42 and pulse generator 43 which are connected in series. The output of the pulse generator 43 is coupled to the data input of a shift register 44, the clock input of which is coupled with the output of a delay cell 45. In addition, the output of a variable gain power amplifier 46 is coupled to the input of an infrared transmitter 47.

The ultrasonic channel 50 comprises an ultrasonic receiver 51, an amplifier 52, a band-pass filter 53, a detector 54 and pulse generator 55 which are connected in series. The output of a variable gain power amplifier 56 is connected to the input of an ultrasonic transmitter 57.

The magnetometer channel 60 comprises a search-coil sensor 61, an amplifier 62 and pulse generator 63 connected in series. The search-coil sensor 61 includes a winding on a core. As illustrated in FIG. 2, the core may be the pole 28 if made of the proper material or alternately a cylindrical core may descend from the housing 21b between the pole 28 and the coil 33. Changes of the magnetic field in the vicinity of the coil will cause changes of the e.m.f. at the winding output which, when amplified by amplifier 62, forms an output voltage that is applied to the pulse generator 63. The search-coil magnetometer 60 is a passive one. It requires no current when the meter 13 is in the sleep mode and minimum current when it is waiting for magnetic field changes. The search-coil magnetometer 60 is powered up only after a payment is made to the meter 13. In the powered up mode, it only requires an extremely small current that is necessary for powering the low power amplifier 62, which draws more current when a signal is generated by the magnetic field change.

The reset device microcontroller 70 includes a first data input 71 coupled from the shift register 44 output, a second data input 72 coupled from the pulse generator 55 output, a third data input 73 coupled from the pulse generator 63 output. A first microcontroller output 74 is coupled to the input of the delay cell 45, second and third microcontroller outputs 75 and 76 are coupled to the signal input and control input of the variable gain power amplifier 46, a fourth output 77 is coupled to the signal input of the variable gain power amplifier 56.

The programmable power supply 80 has a first output 81 connected to the control input of the variable gain power amplifier 56. A control input 82 of the programmable power supply 80 is coupled to a fifth output 78 of the microcontroller 70. A second output 83 of the programmable power supply 80 is the power supply U₁ for both the infrared channel 40 and ultrasonic channel 50 and a third output 84 of the controlled power supply 80 is the power supply U₂ for magnetometer channel 60. The power input 85 of the programmable power supply 80 is connected to a battery 90 which is also connected to the power input 91 of the microcontroller 70. A serial interface 79 couples the microcontroller 70 of the reset device 30 and the electronic parking meter controller 36.

The microcontroller 70 can be implemented using an AMTEL AT90S4433 processor and each of its inputs/outputs can have one or more wires, as necessary. The infrared receiver 41, amplifier 42, pulse generator 43, variable gain power amplifier 46 and transmitter 47 can be built on a HEWLETT-PACKARD optical module HDSL3600. The ultrasonic receiver 51 and transmitter 57 can be implemented using a MURATA ultrasonic transducer MA40E8-2. Other circuit units are standard and can be assembled using available electronic components.

When the parking meter 13 is not timing a parking interval and violation indicator 23 is displayed, the programmable power supply 80 is switched off. Therefore, battery 90 is cut off and no power is available at the power supply 80 outputs 81, 83 and 84. As a result, only a minute current is drawn from battery 90 to the microcontroller 70 which is in sleep mode and so the battery 90 life is extended.

When a driver parks a vehicle 15 in a parking space 12 and inserts a payment into the meter 13, the meter controller 36 removes the violation indicator 23 and starts the parking time interval 25. Simultaneously the controller 36 sends a start signal to microcontroller 70 via interface 79. The microcontroller 70 wakes up, and via its output 78 and programmable power supply 80 input 82 switches power to the output 84 so powering magnetometer channel 60 with a voltage U₂. In operation, the search-coil magnetometer 60 reacts only to changes of the magnetic field and not to the field itself, thus having a large tolerance to magnetic noise. The strong DC magnetic field of the earth will not affect its operation, since it is not sensitive to the constant field. It is therefore not sensitive to stationary magnetic masses, such as the parked car 15 or any other ferromagnetic object; only moving magnetic masses generate a signal at its output.

In the operating mode, the search-coil magnetometer 60 is a passive device and requires little power since it simply waits to detect the movement of a vehicle 15 out of or into a parking space 12. In the prior art reset devices, the vehicle sensors whether they are infrared, ultrasonic or other detectors have to be activated periodically within some time interval to check whether a vehicle is still present in the parking space. This interval is usually not longer than 20-30 seconds to avoid missing the event when one vehicle leaves a space and is replaced by another vehicle. These detectors consume a considerable amount of power while monitoring the parking space. In the present invention the search-coil magnetometer 60 watches for the vehicle movement and other vehicle sensors do not have to be switched on periodically, conserving battery energy.

The movement of a magnetic mass will alter the magnetic field in the search-coil sensor 61 producing a signal which is amplified by the amplifier 62 resulting in the pulse generator 63 generating a pulse with given duration that is fed to the microcontroller 70 through input 73.

The search-coil magnetometer 60 can be triggered by events other than the movement of a vehicle 15 out of a parking space 12. The directivity of the search-coil sensor 61 is rather poor, so a vehicle entering or leaving an adjacent parking space 12 or a large magnetic object transported behind the meters 13 along a sidewalk can also cause a sufficient magnetic field change to trigger the search-coil magnetometer 60.

The infrared and ultrasonic channels 40, 50 are intended to verify whether the triggering was caused by a vehicle 15 leaving the associated parking space 12. When the pulse arrives to the microcontroller input 73, the microcontroller 70 via its output 78 causes the programmable power supply through output 83 to apply power U₁ to infrared channel 40 and ultrasonic channel 50. The microcontroller 70 according to its operating program forms a unique coded pulse sequence signal for its parking meter 13 and via its output 75 applies it to the input of the variable gain power amplifier 46. After the signal is amplified, an infrared beam is transmitted by the infrared transmitter 47 along a path 26 in the direction of a vehicle 15 in the parking space 12 as shown in FIG. 1. If a vehicle 15 is present in the associated parking space 12, the I-R beam is reflected back to the infrared receiver 41 where it is detected. The signal is amplified by amplifier 42 and a pulse sequence is produced by the pulse generator 43. A pulse is fed to the delay cell 45 from the microcontroller output 74 at the same time that the coded pulse sequence is fed to the signal input of the controlled power amplifier 46 from the microcontroller output 75. The delay cell 45 has a fixed time delay equal to the signal propagation time in both the infrared transmitter 47 and receiver 41 as well as to a predetermined travel distance from the transmitter 47 into the parking space 12 and back to the receiver 41. If the distance to a reflecting object is less than the predetermined distance or equal to the predetermined distance, the received pulse sequence delay is less than the time delay of the cell 45 and the pulse passes through the shift register 44 to the microprocessor 70 through its input 71. In this manner, the reflected signal is doubly protected from false recognition: first, the limited predetermined sensitivity distance prevents the use of reflections from remote objects and second, pulse code modulation prevents interference by external continuous sources, such as sun light, artificial lighting and the like.

However, a reflected signal can be detected when there is no vehicle 15 in the associated parking space 12 if the path 26 between the associated parking space 12 and the parking meter 13 have been blocked in an attempt to prevent the parking meter 13 from operating properly (see FIG. 2). This problem is avoided by having the microprocessor 70 via its output 76 set up a series of logical levels at the control input of the variable gain power amplifier 46 which causes a sequential decrease in the I-R radiation level. After receiving the reflected signal at nominal power, the process is repeated several times until the lowest transmitter power is reached. If a reflected signal is detected in all cases, it is an indication that the path 26 has been blocked. Other situations can exist where erroneous readings are detected by the infrared channel 40, for example during a heavy snow fall.

To increase the probability of accurately detecting the absence of a vehicle 15 in a parking space the ultrasonic channel 50 is used. The ultrasonic channel 50 can operate either simultaneously with or subsequent to the infrared channel 40.

The microcontroller 70 forms the same coded pulse sequence and through its output 77 feeds the signal input of the variable gain power amplifier 56. Each pulse is formed into a radio pulse with internal signal frequency equal to ultrasonic transmitter 57 operational frequency f₀. The ultrasonic transmitter 57 radiates the ultrasonic wave along propagation path 26. If a vehicle 15 is present at the associated parking space 12, part of ultrasonic signal is reflected back along reflection path 27 and is received by the receiver 51, amplified by amplifier 52, filtered by band-pass filter 53 with central frequency equal to f₀, detected by detector 54 and formed into a pulse sequence by the pulse generator 55. The pulse sequence is applied to the input 72 of microprocessor 70. Because the speed of sound in the air is relatively slow, about 330 m/s, the microprocessor 70 is able to compare the transmitted and received sequences, and also measure the time delay between them, to determine the distance to the reflected object. Here again the microcontroller 70 through output 78 and the programmable power supply 80 input 82 regulates the transmitted power of the transmitter 57 by the output 81 of the programmable power supply 80 coupled to the control input of the variable gain power amplifier 56. In a similar way as with the infrared channel 40, this process is used to determine whether the ultrasonic channel 50 is blocked and to assure high reliability of its operation. Also using this process, the maximum power necessary for the reliable operation of the I-R and the ultrasonic devices in every particular case can be determined. In this way, a further reduction in power requirements may be achieved in both the infrared and ultrasonic channels 40, 50 and still maintain high reliability.

With the trigger signal from the magnetic channel 60 and the information acquired from the infrared channel 40 and the ultrasonic channel 50 regarding the distance to the parked vehicle 15 or to some obstacle, the microcontroller 70 determines whether the parking space 12 is vacant. If this is the case, the microcontroller 70 via serial interface 79 sends a signal to the parking meter 13 controller 36 to reset the remaining paid time to zero. A violation indicator appears again and the programmable power supply 80 is switched off, so conserving the battery life.

In order to further increase the reliability of the reset device, further improvements may be implemented. For instance, after the microcontroller 70 has been woken-up by the parking meter 13 controller 36 through the payment for parking time, both the infrared channel 40 and the ultrasonic channel 50 may be controlled to radiate a beam toward the vehicle 15 parked in the parking space 12 as a test of their readiness. Such self-testing is possible due to the fact that the vehicle 15 is present in the parking space 12 just after payment is made. If one or both channels 40, 50 detect the presence of the vehicle, then that one or both are working properly.

If the magnetic channel 60 does not give signals at its output during some preselected time, such as after 10 or 20 minute intervals, the microcontroller 70 may be programmed to turn on both the infrared channel 40 and ultrasonic channels 50 to verify the presence of a vehicle. If both channels 40 and 50 confirm that a vehicle is present, the microcontroller 70 returns to the survey mode controlled by the magnetic channel 60. However, the absence of a vehicle in the parking space will be an indication that magnetic channel 60 is not operating properly and the microcontroller 70 will not rely on it to detect a vehicle leaving. In such a situation, either or both the infrared channel 40 and ultrasonic channel 50 are operating periodically, such as every 30 seconds, checking for vehicle presence at the associated parking space.

Further, in order to decrease the reaction of the magnetic channel 60 to the remote strong magnetic sources such as lightning or the discharges caused by surface or underground electric transport, its sensor 61 can be implemented as a measure of the gradient of magnetic field changes, thereby reacting only to nearby sources with strong gradients in the magnetic fields produced by them and thus excluding its triggering from the remote sources with homogeneous fields. This further increases the operation reliability.

A parking meter reset device in accordance with the present invention results in an increased reliability, avoiding the situation when the paid time is reset before the parked vehicle 15 has left the parking space 12. Also, the search coil magnetometer channel 60 causes reset to occur immediately after the parked vehicle 15 leaves the parking space 15 at the expense of minimum power consumption. This results in added revenues for the parking authority.

The reset device is implemented in such a way that it does not thwart the operation of the parking meter even when it is blocked. Only the reset device will be disabled and the parking meter itself will continue to operate, functioning as a non-resettable parking meter.

In a further improvement, the reset device may include a small alarm transmitter controlled by the microcontroller 70. In this case, the magnetometer channel 60 needs to be constantly connected to the power supply so that it can detect a vehicle 15 entering the parking space 12. If a vehicle 15 is detected entering the parking space 12 but the motorist does not pay for parking time, an alarm signal can be transmitted to a central station such that a parking attendant can take appropriate action.

In a further application of the proposed invention, the time elapsed after the paid period has expired with the vehicle 15 remaining in the parking space 12, may be indicated. In such a case when the paid time has expired, the parking meter controller 36 sends the wake-up signal to the reset device 30 and the latter will verify using the infrared and the ultrasonic channels 40, 50 whether the vehicle 15 is still at parking space 12. If this is the case the accumulated time will appear on indicator 25 and the violation indicator 23 will appear in the parking meter 13 window 22.

In the embodiments described, the programmable power supply may be controlled to switch the power supply on and off at any given time to non-operating units, thereby economising the battery. Also, the variable gain power amplifiers may be controlled to transform the radiated beams into a coded sequence; the reflected signal may then be compared with the transmitted signal in order to eliminate possible interference. The embodiments and the implementation of the controller as a single-chip microcontroller give further advantages. First, vehicle movement is initially detected by the magnetic channel having search-coil magnetometer at the input. The pulse from the magnetic channel “wakes up” the microcontroller from a “sleep” mode saving battery power because the search-coil magnetometer is a passive device and it consumes very little power while waiting for magnetic changes, which are to be detected, to occur. This mode normally has a relatively long duration since it is the period of time during which a vehicle is parked. Contrary to prior art devices, energy is being saved during this period since there is no periodic operation of any of ultrasonic and/or infrared devices. Second, modulation of both ultrasonic and infrared beams by coded sequence allows them to be transform into digital form and to process them digitally what excludes both the influence of the external radiation and of the mutual interference with other parking meters operating simultaneously, thereby increasing operation reliability. Also the introduction of variable gain power amplifiers allows the radiated power to be optimized thereby further reducing power consumption and permits the discovery whether the radiation path of the infrared and/or the ultrasonic devices are blocked by comparing the radiated and reflected power.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

What is claimed is:

1. A vehicle monitoring device for a parking meter associated with a parking space comprising:
magnetic vehicle movement detector means;
radiated beam vehicle detector means; and
a controller for receiving a wake-up signal from the parking meter, for activating the magnetic vehicle movement detector means to detect vehicle movement, for activating the radiated beam vehicle detector means to determine the presence/absence of a vehicle in the parking space after vehicle movement has been detected, and for indicating the presence/absence of a vehicle in the parking.

2. A vehicle monitoring device as claimed in claim 1 wherein the magnetic vehicle movement detector means is a magnetometer for detecting changes in adjacent magnetic fields.

3. A vehicle monitoring device as claimed in claim 2 wherein the magnetometer is a search-coil magnetometer.

4. A vehicle monitoring device as claimed in claim 1 wherein the radiated beam vehicle detector means is an infrared detector which comprises:
transmitter means for radiating an infrared beam towards the parking space; and
receiver means for detecting the beam reflected from a vehicle in the parking space.

5. A vehicle monitoring device as claimed in claim 4 wherein the transmitter means comprises:
a transmitter amplifier for amplifying a coded pulse sequence received from the controller; and
a transmitter for transmitting the coded pulse sequence as an infrared beam.

6. A vehicle monitoring device as claimed in claim 5 wherein the transmitter amplifier comprises a variable gain power amplifier controlled by the controller.

7. A vehicle monitoring device as claimed in claim 5 wherein the receiver means comprises:
a receiver for detecting the reflected infrared beam;
a receiver amplifier for amplifying the received signal;
a pulse generator for converting the amplified signal to a pulse;
a delay cell for receiving a signal from the controller when the code pulse sequence is generated; and
a shift register for receiving the outputs of the pulse generator and the delay cell to provide an output to the controller as an indication of the presence of a vehicle.

8. A vehicle monitoring device as claimed in claim 1 wherein the radiated beam vehicle detector means is an ultrasonic detector which comprises:
transmitter means for radiating an ultrasonic beam towards the parking space; and
receiver means for detecting the beam reflected from a vehicle in the parking space.

9. A vehicle monitoring device as claimed in claim 8 wherein the transmitter means comprises:
a transmitter amplifier for amplifying a coded pulse sequence received from the controller; and
a transmitter for transmitting the coded pulse sequence as an ultrasonic beam.

10. A vehicle monitoring device as claimed in claim 9 wherein the transmitter amplifier comprises a variable gain power amplifier controlled by the controller.

11. A vehicle monitoring device as claimed in claim 9 wherein the receiver means comprises:
a receiver for detecting the reflected ultrasonic beam;
a receiver amplifier for amplifying the received signal;
a passband filter for filtering the amplified signal; and
a pulse generator for converting the filtered signal to a pulse to provide an output to the controller as an indication of the presence of a vehicle.

12. A vehicle monitoring device as claimed in claim 1 wherein the radiated beam vehicle detector means includes an infrared detector and an ultrasonic detector, wherein the infrared detector comprises:
transmitter means for radiating an infrared beam towards the parking space; and
receiver means for detecting the beam reflected from a vehicle in the parking space; and
wherein the ultrasonic detector comprises:
transmitter means for radiating an ultrasonic beam towards the parking space; and
receiver means for detecting the beam reflected from a vehicle in the parking space.

13. A parking meter reset device for a parking meter associated with a parking space comprising:
magnetic vehicle movement detector means;
radiated beam vehicle detector means; and
a controller comprising:
means for receiving a wake-up signal from the parking meter as the parking meter receives payment;
means for activating the magnetic vehicle movement detector means in response to the wake-up signal to detect vehicle movement;
means for activating the radiated beam vehicle detector means in response to a signal from the magnetic vehicle movement detector means to determine the presence/absence of a vehicle in the parking space; and
means for resetting the parking meter in response to a signal from the radiated beam vehicle detector means indicating the absence of a vehicle in the parking space.

14. A parking meter reset device as claimed in claim 13 wherein the magnetic vehicle movement detector means is a magnetometer for detecting changes in adjacent magnetic fields.

15. A parking meter reset device as claimed in claim 14 wherein the magnetometer is a search-coil magnetometer.

16. A parking meter reset device as claimed in claim 13 wherein the radiated beam vehicle detector means is an infrared detector which comprises:
transmitter means for radiating an infrared beam towards the parking space; and
receiver means for detecting the beam reflected from a vehicle in the parking space.

17. A parking meter reset device as claimed in claim 13 wherein the radiated beam vehicle detector means is an ultrasonic detector comprises:
transmitter means for radiating an ultrasonic beam towards the parking space; and
receiver means for detecting the beam reflected from a vehicle in the parking space.

18. A parking meter reset device as claimed in claim 13 wherein the radiated beam vehicle detector means includes an infrared detector and an ultrasonic detector, wherein the infrared detector comprises:
transmitter means for radiating an infrared beam towards the parking space; and
receiver means for detecting the beam reflected from a vehicle in the parking space; and
wherein the ultrasonic detector comprises:
transmitter means for radiating an ultrasonic beam towards the parking space; and
receiver means for detecting the beam reflected from a vehicle in the parking space.

19. A parking meter reset device as claimed in claim 18 wherein the controller means for activating the radiated beam vehicle detector means comprises:
first means for activating the infrared detector in response to a signal from the vehicle movement detector means; and
second means for activating the ultrasonic detector in response to the output from the infrared detector.

20. A parking meter reset device as claimed in claim 18 wherein the controller means for activating the radiated beam vehicle detector means comprises:
first means for activating the infrared detector in response to a signal from the vehicle movement detector means; and
second means for simultaneously activating the ultrasonic detector in response to a signal from the vehicle movement detector means.

21. A parking meter reset device as claimed in claim 13 wherein the controller means for activating the radiated beam vehicle detector means is the parking meter controller.

22. A method of resetting a parking meter associated with a parking space for a vehicle comprising the steps:
a. magnetically sensing the movement of a vehicle within the parking space;
b. subsequently detecting the absence of the vehicle within the parking space; and
c. cancelling any paid time on the meter.

23. A method of resetting a parking meter as claimed in claim 22 wherein step a. comprises:
a.1. sensing a payment for parking time on the meter; and
a.2. activating a magnetic vehicle movement detector.

24. A method of resetting a parking meter as claimed in claim 22 wherein step b. comprises:
b.1. activating an infrared vehicle detector in response to a sensed vehicle movement;
b.2. transmitting an infrared beam towards the parking space; and
b.3. detecting the absence of a reflected beam as an indication of the absence of a vehicle in the parking space.

25. A method of resetting a parking meter as claimed in claim 24 wherein step b. further comprises:
b.4. activating an ultrasonic vehicle detector in response to the detected vehicle absence by the infrared detector;
b.5. transmitting an ultrasonic beam towards the parking space; and
b.6. detecting the absence of a reflected beam as a confirmation of the absence of a vehicle in the parking space.

26. A method of resetting a parking meter as claimed in claim 24 wherein step b. further comprises:
b.4. activating an ultrasonic vehicle detector in response to a sensed vehicle movement substantially simultaneously with the infrared detector;
b.5. transmitting an ultrasonic beam towards the parking space; and
b.6. detecting the absence of a reflected beam as an indication of the absence of a vehicle in the parking space.

27. A method of resetting a parking meter as claimed in claim 22 wherein step b. comprises:
b.1. activating an ultrasonic vehicle detector in response to a sensed vehicle movement;
b.2. transmitting an ultrasonic beam towards the parking space; and
b.3. detecting the absence of a reflected beam as an indication of the absence of a vehicle in the parking space.

28. A method of resetting a parking meter as claimed in claim 27 wherein step b. further comprises:
b.4. activating an infrared vehicle detector in response to the detected vehicle absence by the ultrasonic detector;
b.5. transmitting an infrared beam towards the parking space; and
b.6. detecting the absence of a reflected beam as a confirmation of the absence of a vehicle in the parking space.

29. A method of resetting a parking meter as claimed in claim 22 wherein step b. comprises:
b.1. activating an infrared vehicle detector in response to a sensed vehicle movement;
b.2. transmitting an infrared beam at a predetermined amplification level along a propagation path towards the parking space; and
b.3. detecting a reflected beam; and
b.4. repeating steps b.1., b.2. and b.3. at different amplification levels whereby the repeated detection of a reflected beam is an indication of a blocked propagation path.

30. A method of resetting a parking meter as claimed in claim 22 wherein step b. comprises:
b.1. activating an ultrasonic vehicle detector in response to a sensed vehicle movement;
b.2. transmitting an ultrasonic beam at a predetermined amplification level along a propagation path towards the parking space; and
b.3. detecting a reflected beam; and
b.4. repeating steps b.1., b.2. and b.3. at different amplification levels whereby the repeated detection of a reflected beam is an indication of a blocked propagation path.

31. A method of resetting a parking meter associated with a parking space for a vehicle comprising the steps:
a. sensing a payment for parking time on the meter;
b. activating a radiated beam vehicle detector in response to sensed payment;
c. transmitting the radiated beam towards the parking space;
d. detecting the presence of a reflected beam from a vehicle parked within the parking space to calibrate the radiated beam vehicle detector;
e. activating a magnetic vehicle movement detector to sense the movement of the vehicle within the parking space;
d. subsequently detecting the absence of the vehicle within the parking space using the radiated beam vehicle detector; and
e. cancelling any paid time on the meter.

32. A method of resetting a parking meter as claimed in claim 31 wherein the radiated beam vehicle detector is an infrared vehicle detector and/or an ultrasonic vehicle detector.
